(19) United States
(12) Patent Application Publication
(10) Pub. No.: US 2013/0194930 A1
(43) Pub. Date: Aug. 1, 2013

(54) Application Identification Through Data Traffic Analysis

(71) Applicants: Geza Szabo, Kecskemet (HU); Zoltán Richárd Turányi, Szentendre (HU)

(72) Inventors: Geza Szabo, Kecskemet (HU); Zoltán Richárd Turányi, Szentendre (HU)

(73) Assignee: Telefonaktiebolaget L M Ericsson (publ), Stockholm (SE)

(21) Appl. No.: 13/876,288

(22) PCT Filed: Oct. 14, 2010
(86) PCT No.: PCT/EP2010/065413

§ 371 Date: Mar. 27, 2013

(51) Int. Cl. H04L 12/26

(52) U.S. Cl. CPC H04L 43/0876
USPC 370/235; 370/241

(57) ABSTRACT

There is provided a method of processing, analysing or profiling traffic in a packet switched telecommunications network. During a first phase (S1 to S4), for each of a plurality of applications, traffic generated by the application is analysed (S2) to identify a collection of one or more characteristic bit sequences for the application, or at least such a plurality of collections is provided. During a second phase (S5 to S11), traffic is received from the network (S5), and the following steps are performed for each of at least one of the plurality of collections: (i) for each of at least one of the characteristic bit sequences in the collection: a sequence alignment process (S8) is performed on the received traffic against the characteristic bit sequence to derive a per-sequence score; and (ii) a per-collection score is assigned to the collection (S10) based on the per-sequence scores for the collection, the per-collection score being indicative of a likelihood that the traffic was generated by the application associated with the collection.

### TECHNICAL FIELD

The present invention relates to a method and apparatus for processing traffic in a packet switched telecommunications network.

### BACKGROUND

Gaining an in-depth understanding of the Internet traffic profile is a challenging task, and an important requirement for most Internet Service Providers (ISP). To this end, Deep Packet Inspection (DPI) helps ISPs in the quest for profiling networked applications. With this information in hand, ISPs may then apply different charging policies, traffic shaping, and offer different QoS guarantees to selected users or applications. Many critical network services may rely on the inspection of packet payload content, instead of only looking at the structured information found in packet headers. It is clear that forwarding or analyzing packets based on content requires new techniques in network devices.

First DPI tools and techniques have relied on simple mechanisms that basically compare the content of the packet payload with a set of strings, which essentially represents a given “signature” from an application. Recently, DPI techniques are replacing strings sets with regular expressions due to their increased expressiveness. Systems requiring DPI are Network Intrusion Detection and Prevention Systems (NIDS/NIPS), Layer 7 network devices (switches, firewalls, etc), and content-based traffic management. Such systems frequently perform a set of time-critical operations to verify certain network patterns or behavior while trying to minimize packet processing latency.

Most DPI systems express patterns using regular expressions [Smith, R., Estan, C., Jha, S., and Kong, S. 2008. “Deflating the big bang: fast and scalable deep packet inspection with extended finite automata”. SIGCOMM Comput. Commun. Rev. 38, 4 (Oct. 2008), 207-218. DOI=http://doi.acm.org/10.1145/1402946.1402983]. A natural way to perform pattern matching is through the use of Finite Automaton (FA). FAs are state machines that can recognize patterns expressed by regular expressions.

The most accurate method to recognize protocols would be complete protocol parsing. As these techniques are very resource consuming, DPI is used which searches for characteristic byte signatures in the traffic. This technique is accepted to be the most accurate among the traffic classification techniques [A. Callado, G. Szabo, B. P. Gero, J. Kelner, S. Fernandes, D. Sadok: Survey on Internet Traffic Identification and Classification, IEEE Communications Surveys and Tutorials, 2009, Vol. 11, Num. 3, pp. 37-52] but it should be noted that this technique remains a heuristic. For example, the chance of encountering a specific DPI signature in a uniformly distributed network traffic—in terms of byte values—is ˜11256^{L} where L is the length of the signature.

The present applicant has appreciated that current DPI based systems consider the result of the DPI system as a final verdict. In case of a match occurs, the traffic is classified to the signature of the application which generated the hit. All information in connection with the reliability of the hit is lost.

Those signatures which are very characteristic feature of the protocol—e.g., ‘@hotmail.com’ for MSN traffic—on one hand but may create false positive hits on the other can not be used in the DPI systems at all as it would make the whole process unreliable.

In case there are minor changes in the protocol for which a specific regular expression matches, e.g. an insertion of a new optional field, the regular expression has to be updated.

The present applicant has appreciated the desirability of providing an improved method for processing and analysing traffic in a packet switched telecommunications network.

### SUMMARY

There is provided a method of or for use in processing, analysing or profiling traffic in a packet switched telecommunications network. During a first phase, for each of a plurality of applications, traffic generated by the application is analysed to identify a collection of one or more characteristic bit sequences for the application, or at least such a plurality of collections is provided. During a second phase, traffic is received from the network, and the following steps are performed for each of at least one of the plurality of collections: (i) for each of at least one of the characteristic bit sequences in the collection: a sequence alignment process is performed on the received traffic against the characteristic bit sequence to derive a per-sequence score; and (ii) a per-collection score is assigned to the collection based on the per-sequence scores for the collection, the per-collection score being indicative of a likelihood that the traffic was generated by the application associated with the collection.

The method may comprise managing traffic in the network based on the per-collection scores, or at least arranging for or causing such managing.

Managing traffic may comprise at least one of: determining or applying a charging policy in the network, traffic shaping in the network, and determining or applying a QoS guarantee in the network.

The method may comprise analysing or profiling the received traffic based on the per-collection scores, or at least arranging for or causing such analysing or profiling.

The method may comprise identifying the application that generated the received traffic based on the per-collection scores.

The application that generated the received traffic may be identified as being the application associated with the collection having a per-collection score that is indicative of the highest likelihood.

At least one of the applications may represent a group or class of applications, for example applications of the same or similar type.

The received traffic may comprise a plurality of packets.

Accumulated per-collection scores may be maintained for the respective collections, such that at least one step that is performed based on per-collection scores is performed at least partly based on the accumulated per-collection scores. The accumulated per-collection scores may be normalised.

The per-collection score for a collection may be derived from at least one of the mean, mode and median of the per-sequence scores for the collection.

An apparatus is provided for processing, analysing or profiling traffic in a packet switched telecommunications network. An element is provided for, in relation to each of a plurality of applications: analysing traffic generated by the application to identify a collection of one or more characteristic bit sequences for the application, or at least providing such a plurality of collections. An element is provided for receiving traffic from the network. An element is provided for, in relation to each of at least one of the plurality of collections, performing the following steps: for each of at least one of the characteristic bit sequences in the collection: performing a sequence alignment process on the received traffic against the characteristic bit sequence to derive a per-sequence score; and assigning a per-collection score to the collection based on the per-sequence scores for the collection, the per-collection score being indicative of a likelihood that the traffic was generated by the application associated with the collection.

There is provided a program for controlling an apparatus to perform a method as set out above or which, when loaded into an apparatus, causes the apparatus to become an apparatus as set out above. The program may be carried on a carrier medium. The carrier medium may be a storage medium. The carrier medium may be a transmission medium. There is provided an apparatus programmed by such a program. There is provided a storage medium containing such a program.

An embodiment of the present invention offers a technical advantage of addressing the issue mentioned above relating to the prior art. Technical advantages are set out in more detail below.

### BRIEF DESCRIPTION OF THE DRAWINGS

FIG. 1 illustrates schematically apparatus according to an embodiment of the present invention;

FIG. 2 is a schematic flowchart illustrating a method according to an embodiment of the present invention;

FIG. 3 is a plot illustrating the total sum of alignment scores per application vs the application motifs;

FIG. 4 is a plot illustrating the sum of {sum score/number of flows} value per motif cluster;

FIG. 5 shows several possible network nodes in which an embodiment of the present invention could be implemented; and

FIG. 6 schematically illustrates parts of the apparatus of FIG. 1 in more detail.

### DETAILED DESCRIPTION

As mentioned above, it is desirable to provide an improved method for processing and analysing traffic in a packet switched telecommunications network.

Advanced string matching techniques, known as sequence alignment techniques, are used in bioinformatics. Sequence alignment is a way of arranging the sequences of DNA, RNA, or protein to identify regions of similarity that may be a consequence of functional, structural, or evolutionary relationships between the sequences. Aligned sequences of nucleotide or amino acid residues are typically represented as rows within a matrix. Gaps are inserted between the residues so that identical or similar characters are aligned in successive columns. If two sequences in an alignment share a common ancestor, mismatches can be interpreted as point mutations and gaps as indels (that is, insertion or deletion mutations) introduced in one or both lineages in the time since they diverged from one another. In sequence alignments of proteins, the degree of similarity between amino acids occupying a particular position in the sequence can be interpreted as a rough measure of how conserved a particular region or sequence motif is among lineages. The absence of substitutions, or the presence of only very conservative substitutions (that is, the substitution of amino acids whose side chains have similar biochemical properties) in a particular region of the sequence, suggest that this region has structural or functional importance. Sequence alignment is described, for example, in the book “Sequence Alignment: methods, models, concepts, and strategies” by Michael S. Rosenberg.

Motif finding algorithms can be used to create regular expressions [“Randomized algorithms and motif finding,” http://bix.ucsd.edu/bioalgorithms/presentations/Ch12_RandAlgs.pdf]. Unraveling the mechanisms that regulate gene expression is a major challenge in biology. An important task in this challenge is to identify regulatory elements, especially the binding sites in deoxyribonucleic acid (DNA) for transcription factors. These binding sites are short DNA segments that are called motifs. Recent advances in genome sequence availability and in high-throughput gene expression analysis technologies have allowed for the development of computational methods for motif finding. As a result, a large number of motif finding algorithms have been implemented and applied to various motif models over the past decade.

[Tian Song; Yibo Xue; Dongsheng Wang, “An Algorithm of Large-Scale Approximate Multiple String Matching for Network Security,” First International Conference on Communications and Networking in China, 2006. ChinaCom '06., vol., no., pp.1-5, 25-27 Oct. 2006, URL: http://ieeexplore.ieee.org/stamp/stamp.jsp?arnumber=4149803&isnumber=4117415] introduces a kind of approximate string matching technique to use it on network traffic, but their focus is on the algorithm and its performance is measured, but a feasible system architecture and the practical use cases were not investigated.

An embodiment of the present invention uses an approximate string matching (ASM) technique based on a sequence alignment procedure for Deep Packet Inspection. ASM defines scores for the characterization of the goodness of fitting for a signature on an input candidate.

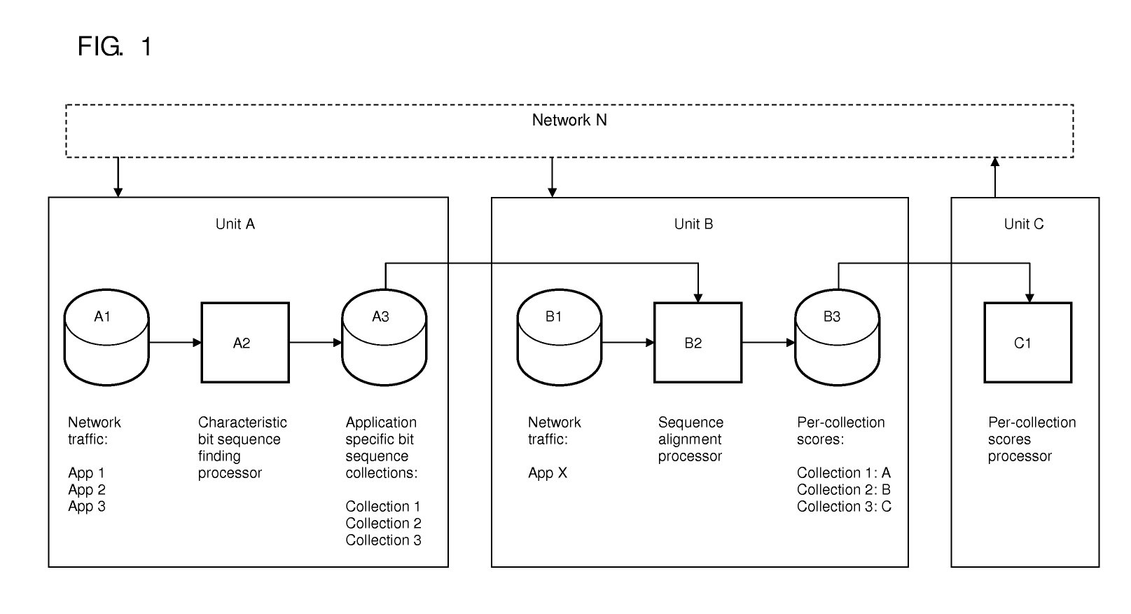

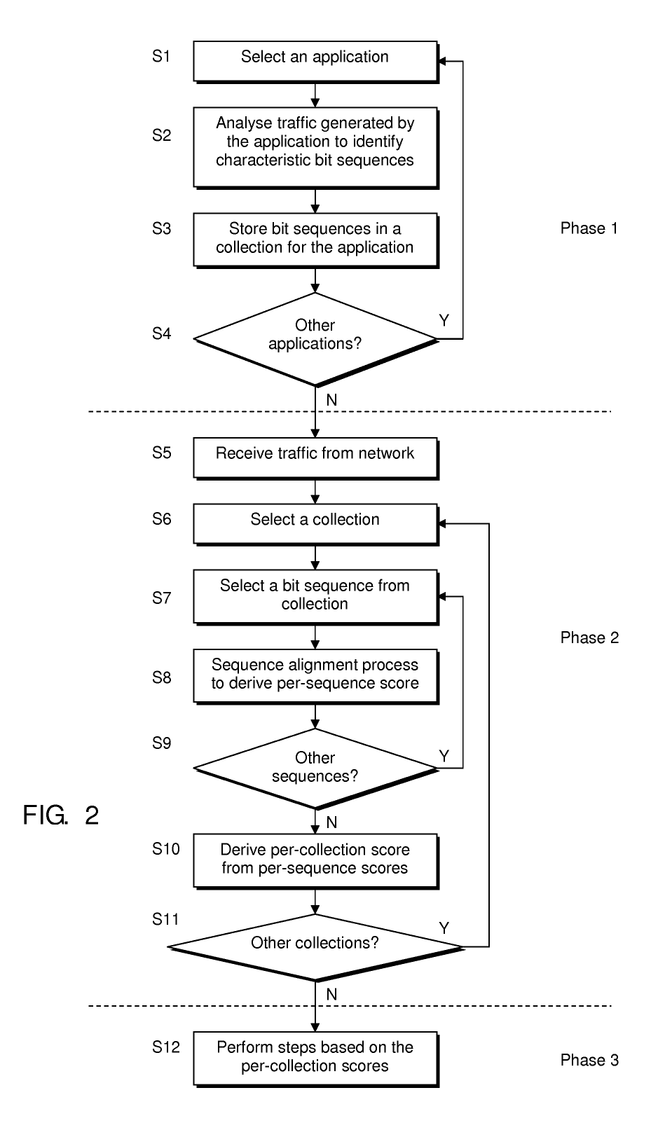

Apparatus according to an embodiment of the present invention is shown illustratively in FIG. 1, comprising three main units: unit A, unit B and unit C. A schematic flow chart is provided in FIG. 2 to illustrate the method performed by the apparatus of FIG. 1. The method of FIG. 2 is shown as divided into three phases: phase 1, phase 2, and phase 3. These three phases 1, 2 and 3 are performed respectively by units 1, 2 and 3. Phase 1 is a characteristic bit sequence (or motif) finding phase. Phase 2 is a sequence alignment phase. Phase 3 is a phase in which various steps may be performed based on the results of phase 2.

In more detail, phase 1 is for finding characteristic bit sequences for a plurality of different applications. A characteristic bit sequence for an application can be considered to be a sequence of bits that occurs regularly or consistently in traffic generated by that application (a re-occuring bit sequence), and/or which can be said to characterise the traffic generated by that application. Characteristic bit sequences are often referred to in the literature as motifs or signatures.

Unit A has a source A1 of traffic generated by a plurality of different applications, with the application that generated the traffic being known. The source A1 may be a store (for example a temporary store) of traffic collected from network N, or may be a direct feed or input from the network N. In this sense, traffic may comprise a single packet, though more usually it would comprise a plurality of packets. For example a single application may generate a lot of traffic, the first several packets of which should be inspected since they comprise the characteristic bit sequences; further packets comprise data only, which are not generally characteristic to the application.

Steps S1 to S4 of FIG. 2 are performed by processor A2 of unit A. In step S1, one of (or the next one of) the applications is selected for processing, and in step S2 the traffic associated with that application is received or retrieved or filtered out from source A1 and analysed to identify a collection of one or more characteristic bit sequences (or motifs or signatures) for the application. In step S3 the collection of characteristic bit sequences for the application is stored in storage A3 of unit A. In step S4 it is determined whether there are further applications of the plurality to process; if so then processing passes back to step S1 and if not then processing continues to step S5.

There are several well known motif finding tools which can be used in step S2. For example, the technique disclosed in [Frith M C, Saunders N F W, Kobe B, Bailey T L, 2008 Discovering Sequence Motifs with Arbitrary Insertions and Deletions. PLoS Comput Biol 4(5): e1000071. doi:10.1371/joumal.pcbi.1000071] can be used to process the network traffic and create application specific characteristic bit sequences accordingly. With several iterative runs the process can end up in several candidate characteristic bit sequences which are expected to be characteristic for different types of application traffic. For example, several characteristic bit sequences can be found for signaling and data transfer flows of the same Peer-to-peer (P2P) application.

In the example shown in FIG. 1, the traffic for three applications App 1, App 2 and App 3 are illustrated in traffic source A1. After processing by the characteristic bit sequence finding processor A2, three collections (Collection 1, Collection 2, and Collection 3) of application-specific characteristic bit sequences, corresponding respectively to App 1, App 2 and App 3, have been found and placed in storage A3 (or sent directly to unit B).

The analysis and/or identification of unknown traffic is subsequently performed by unit B by performing a sequence alignment process on the unknown traffic against the characteristic bit sequences found by unit A. Unit B has a source B1 of network traffic. The source B1 may be a store (for example a temporary store) of traffic collected from network N, for processing offline, or may be a direct feed or input from the network N, for processing online or in real time. Receipt of the traffic at unit B is represented by step S5 of FIG. 2. Steps S6 to S11 are performed by a sequence alignment processor B2 of unit B. In step S6 one (or the next) of the plurality of collections in the store A3 is selected for processing. Within the selected collection, one (or the next) of the characteristic bit sequences in the collection is selected in step S7 for processing.

In step S8 a sequence alignment process is performed on the received traffic against the selected characteristic bit sequence to derive a per-sequence score. In step S9 it is determined whether there are any further characteristic bit sequences in the current collection to process. If yes, then processing returns to step S7; if not, then processing continues to step S10. In step S10, a per-collection score is assigned to the current collection based on the per-sequence scores for the collection. The per-collection score can be considered to be indicative of a likelihood that the traffic received in step

S5 was generated by the application associated with the collection. The per-collection score for the collection can be derived from the mean, mode or median of the per-sequence scores for the collection.

In step S11 it is determined whether there are any further collections of characteristic bit sequence from the store A3 to process. If yes, then processing returns to step S6; if not, then processing continues to step S12.

A number of different possibilities are envisaged for step S12, which is performed by the per-collection scores processor C1 of unit C, with the common factor being that step S12 represents a process that uses the per-collection scores from step S10.

For example, step S12 may comprise identifying the application that generated the traffic received in step S5 based on the per-collection scores. The application that generated the received traffic may be identified as being the application associated with the collection having a per-collection score that is indicative of the highest likelihood. Where the scoring scheme is such that a higher per-collection score is indicative of a higher likelihood, this would amount to selecting the application associated with the collection having the highest per-collection score. For example, in the illustration shown in FIG. 1, traffic from unknown application App X is received, and the per-collection scores derived for each of the Collections 1, 2 and 3 are A, B and C respectively. If per-collection score C is greatest, then App X can be identified as (most likely being) App 3, which is the application associated with Collection C.

Step S12 may comprise analysing or profiling the received traffic based on the per-collection scores, or at least arranging for or causing such analysing or profiling. Step S12 may comprise managing traffic in the network N based on the per-collection scores, or at least arranging for or causing such managing. In this respect, managing traffic may comprise determining or applying a charging policy in the network. It may comprise traffic shaping in the network. It may comprise determining or applying a QoS guarantee in the network.

This is particularly applicable in the situation where steps S5 to S11 are repeated multiple times, to gather information relating to a significant amount of network traffic. Repetition of these steps would allow accumulated per-collection scores to be determined, such that further analysis or processing can be based on the accumulated per-collection scores. The per-collection scores are accumulated by summing the respective per-collection scores from different passes through steps S5 to S11. The accumulated per-collection scores can be analysed or reviewed to get a sense for which applications are generating most traffic over the network, which in turn may be used to manage traffic in the network as mentioned above.

These accumulated per-collection scores may be normalised, for example based on the number of traffic flows that are being processed. In this respect, in a TCP/IP context a “flow” can be considered to be a TCP/IP connection between two end points, identified e.g. by source/destination port and IP addresses. There are several scenarios that can be considered in relation to normalisation:

Firstly, where the unknown flows are considered one-by-one, no normalisation is required. The traffic for a particular flow can be processed using a method as described above, with the information being used directly to determine which application most likely generated that traffic.

Secondly, the unknown flows can be considered per host, per port (i.e. the same generating client host from the same source port to several destination IPs and ports); this is a regular behaviour of services. One basic example of this is a web server, where the clients access TCP port 80 from many different IPs coming from any possible ports. From the view of the web server, the flows can be considered as the ‘same’ application as they access the same service. If the web server also hosts an SNMP mail server, then flows going to port 25 have similar behavior and also can be considered together. These examples related to well-known common services, but P2P clients work similar way as it has to have a server-port open for incoming p2p connections.

Thirdly, the unknown flows can be considered per host. In such a case it can be determined that the user has a mix of specific applications. This information is also helpful in case the task is user profiling.

Fourthly, another possible use case is that an active measurement is taken and the task is to categorize the new application into existing ones. For example, suppose that a new P2P client is being released. It is installed and a measurement is done with a PC. The task is to match it to existing motif-application collections whether the application uses BitTorrent protocol, eDonkey, etc. or come completely new type. In such a case normalisation can be also done. It is known in advance that the set of flows belongs to the same application.

In each of the second to fourth scenarios described above, it may be appropriate to normalise the per-collection scores based on flow numbers.

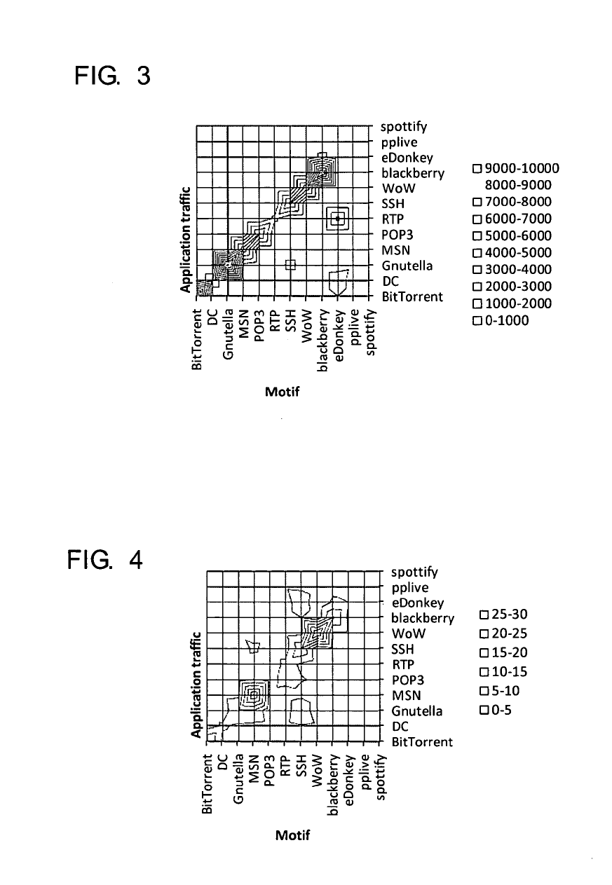

By way of example, characteristic bit sequence collections were created for twelve different applications, and these characteristic bit sequence collections were tested on each others' traffic (1000 sample flows of each application). FIG. 3 shows the accumulated per-collection alignment scores for each collection, depicted in contour form. For example, for application traffic known to be generated by Gnutella, reading along the horizontal axis labelled Gnutella, one can see a very high score of between 9000 and 10000 against the Gnutella characteristic bit sequence collection, with a very low score (around 0) on the surrounding intersections. The various score contours in between are drawn onto the plot, resulting in very tightly packed contours around the Gnutella-Gnutella intersection. Reading further along the horizontal axis labelled Gnutella, one can see a lower high score of between 1000 and 2000 against the SSH characteristic bit sequence collection, indicating that the traffic generated by the Gnutella application has at least some similarity with the SSH application, resulting in a non-zero score for SSH. Although the details of FIG. 3 is difficult to interpret without the benefit of colour, it should be appreciated that the first contour encountered when moving towards one of the peaks is the 0-1000 contour, and the other listed contours (1000-2000, 2000-3000, etc) are encountered in turn as one moves towards the peak. The scoring scheme used for FIG. 3 means that the number of flows will influence the overall score, so that a large number of flows each generating a small score for a particular collection will still have a large impact on the overall score for that collection.

FIG. 4 shows another scoring scheme, where the accumulated per-cluster scores have been normalized with flow number; such a scoring scheme avoids the possible dominating effect that applications generating large flow numbers can have on the overall scores.

The results show that the highest scores occur mostly in the diagonal. These scores reflect the existence of unambiguous characteristic bit sequence collections for most of the applications, e.g. BitTorrent, MSN, Gnutella, POP3, etc.

However, in some cases the collections can be ambiguous considering only one of the scoring schemes. For example, in FIG. 3 eDonkey conflicts with DC (which may occur due to multiple protocol usage of the same client), but the case of RTP has no straightforward explanation. Thus it is advisable to take more than one scoring scheme into account in during decision making.

It will be appreciated that an “application” in the context of an embodiment of the present invention can be considered to represent a single application, or a group or class of applications, for example applications of the same or similar type, and the term “application” is to be understood accordingly. In this regard, it may be useful to have the ability to classify traffic into a broad class of applications, such as “P2P applications”, rather than identify the traffic as having been generated by a specific application.

Comparing the calculation complexity of the ASM with Deterministic Finite Automata (DFA) the following can be found. The DFA has O(n) complexity where n is the length of input string. The sequence alignment has O(nm) complexity [Hans-Joachim Böckenhauer, Dirk Bongartz: Algorithmic aspects of bioinformatics, Springer, ISBN-978-3-540-71912-0 2007] where n is the length of the input string, m is the length of the motif. The difference is linear, thus the algorithm may be a proper candidate on e.g., post processing of such traffic which can not be identified with the common DPI techniques.

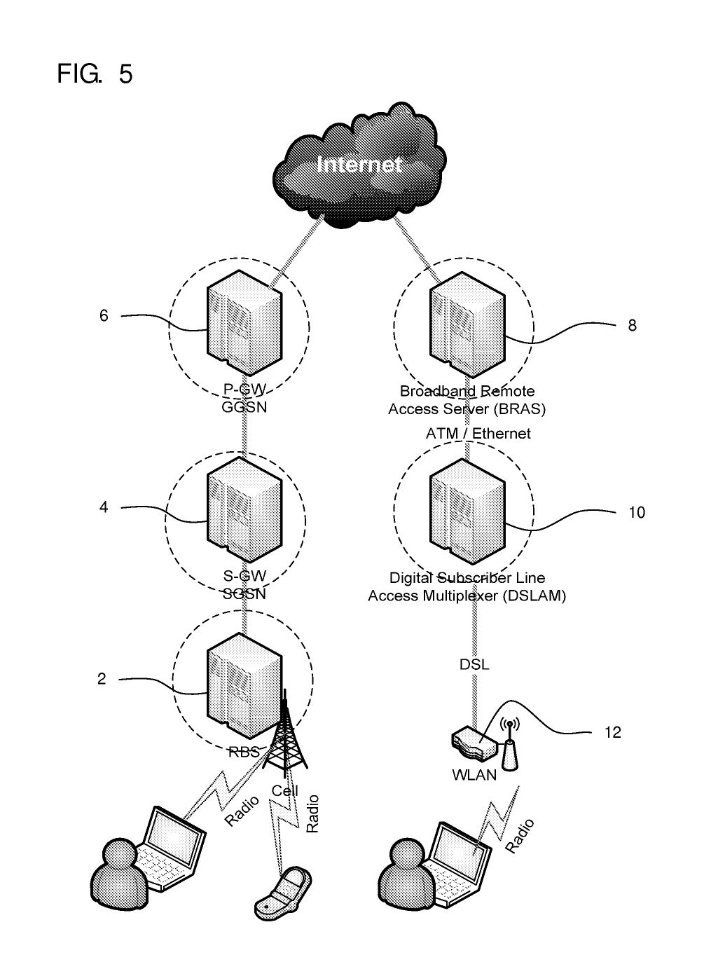

FIG. 5 illustrates several possible network nodes in which an embodiment of the present invention could be implemented. Example network nodes that are suitable for supporting functionality according to an embodiment of the present invention are those such as gateway nodes (e.g. serving and packet gateway nodes) which are in a position to observe the network traffic of several users. Examples shown in FIG. 4 are a Radio Base Station (RBS) 2, a Serving GPRS Support Node (SGSN) 4, a Gateway GPRS Support Node (GGSN) 6 in a 3G network, and a Broadband Remote Access Server (BRAS) 8 and a Digital Subscriber Line Access Multiplexer (DSLAM) 10 in a DSL network. A Wireless Local Area Network (WLAN) access point 12 is a relatively low aggregation point and therefore is a less preferred candidate.

One advantage of an embodiment of the invention is to enable the DPI engines to use such signature sets which would otherwise give false positive hits on their own. For example, ‘@hotmail.com’ for MSN is a good factor of the sum characteristic bit sequence score (as the MSN passports usually creates a hotmail address for the user), but not application specific on its own. As not necessarily every characteristic bit sequence is specific for only one application but using the sum of the characteristic bit sequence scores for one specific application make them a fairly reliable indicator for an application.

It is also an advantage of an embodiment of the invention when such characteristic bit sequences are the application descriptors which known to be changed deliberately, e.g. for e-mail spam and other text-like characteristics protocols, e.g., VIAGRA 4 V.I.A.G.R.A.

The characteristic bit sequences are even more robust for protocol version changes over time than regular expressions. For example, new option fields in a protocol do not affect the characteristic bit sequences much.

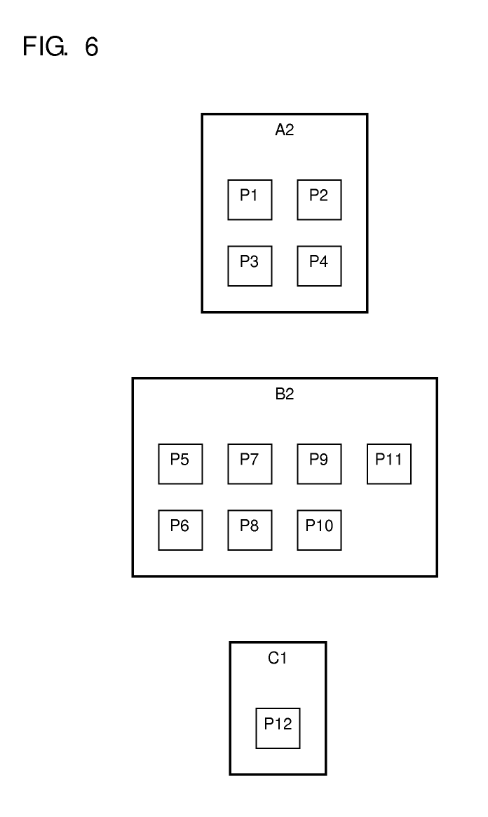

Each of the blocks illustrated in FIG. 2 can be considered to represent physical means for performing the function associated with the block. Thus, blocks S1 to S4 can be considered to represent respective blocks within unit A2, blocks S5 to S11 can be considered to represent respective blocks within unit B2, and block S12 can be considered to represent a block within unit C1. This is illustrated in more detail in FIG. 6, which shows processors P1 to P4 in unit A2 for performing steps S1 to S4 respectively, processors P5 to P11 in unit B2 for performing steps S5 to S11 respectively, and processor P12 in unit C1 for performing step S12.

It will be appreciated that operation of one or more of the above-described components can be provided in the form of one or more processors or processing units, which processing unit or units could be controlled or provided at least in part by a program operating on the device or apparatus. The function of several depicted components may in fact be performed by a single component. A single processor or processing unit may be arranged to perform the function of multiple components. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

It will also be appreciated that although units A, B and C as shown in FIG. 1 may be provided in a single apparatus in a single location, it is also possible that the three units A, B and C are provided in three separate locations. Example locations are illustrated in FIG. 5 and described above. In particular, the characteristic bit sequence finding tasks performed in phase 1 by unit A may be performed in advance by a third party, with the results (collections of characteristic bit sequences) from phase 1 being provided subsequently as input to phase 2. Likewise, the results (per-collection scores) from phase 2 need not be used straight away in phase 3, but instead may be stored and distributed to another location for the performance there of the phase 3 analysis. The appended claims are intended in particular to cover the method of phase 2 and unit B in isolation, but are also intended to cover any of the other phases and units in isolation, and any combination of phases 1, 2 and 3, and any combination of units A, B and C.

It will also be appreciated by the person of skill in the art that various modifications may be made to the above-described embodiments without departing from the scope of the present invention as defined by the appended claims.

1-15. (canceled)

16. A method of processing traffic in a packet switched telecommunications network, the method comprising:
(a) performing at least one of:
analysing, for each of a plurality of applications, traffic generated by the application to identify a collection of one or more characteristic bit sequences for the application;
providing a plurality of such collections;
(b) receiving traffic from the network; and
(c) for each of at least one of the plurality of collections:
(i) performing, for each of at least one of the characteristic bit sequences in the collection, a sequence alignment process on the received traffic against the characteristic bit sequence to derive a per-sequence score; and
(ii) assigning a per-collection score to the collection based on the per-sequence scores for the collection, the per-collection score being indicative of a likelihood that the traffic was generated by the application associated with the collection.

17. The method of claim 16, further comprising managing traffic in the network based on the per-collection scores.

18. The method of claim 17, wherein the managing traffic comprises at least one of:
determining or applying a charging policy in the network;
traffic shaping in the network; and
determining or applying a Quality of Service guarantee in the network.

19. The method of claim 16, further comprising analyzing or profiling the received traffic based on the per-collection scores.

20. The method of claim 16, further comprising identifying the application that generated the received traffic based on the per-collection scores.

21. The method of claim 20, wherein identifying the application that generated the received traffic comprises identifying the application that generated the received traffic as an application from the plurality of applications having a per-collection score that is indicative of the highest likelihood.

22. The method of claim 16, wherein at least one of the applications represents a group or class of applications.

23. The method of claim 16, wherein the received traffic comprises a plurality of packets.

24. The method of claim 16:
further comprising repeating steps (b) and (c) to assign accumulated per-collection scores to the respective collections;
wherein at least one of the following is performed based on the accumulated per-collection scores:
managing traffic in the network;
analyzing or profiling the received traffic;
identifying the application.

25. The method of claim 24, further comprising normalizing the accumulated per-collection scores.

26. The method of claim 16, wherein the per-collection score for a collection is derived from at least one of the mean, mode, and median of the per-sequence scores for the collection.

27. An apparatus for processing traffic in a packet switched telecommunications network, comprising:
one or more processing circuits configured to:
perform at least one of:
analysing, for each of a plurality of applications, traffic generated by the application to identify a collection of one or more characteristic bit sequences for the application;
providing a plurality of such collections;
receive traffic from the network; and
for each of at least one of the plurality of collections:
perform, for each of at least one of the characteristic bit sequences in the collection, a sequence alignment process on the received traffic against the characteristic bit sequence to derive a per-sequence score; and
assign a per-collection score to the collection based on the per-sequence scores for the collection, the per-collection score being indicative of a likelihood that the traffic was generated by the application associated with the collection.

28. A computer program product stored in a non-transitory computer readable medium for controlling a programmable network entity in a packet switched telecommunications network, the computer program product comprising software instructions which, when run on the programmable network entity, causes the programmable network entity to:
perform at least one of:
analysing, for each of a plurality of applications, traffic generated by the application to identify a collection of one or more characteristic bit sequences for the application;
providing a plurality of such collections;
receive traffic from the network; and
for each of at least one of the plurality of collections:
perform, for each of at least one of the characteristic bit sequences in the collection, a sequence alignment process on the received traffic against the characteristic bit sequence to derive a per-sequence score;
assign a per-collection score to the collection based on the per-sequence scores for the collection, the per-collection score being indicative of a likelihood that the traffic was generated by the application associated with the collection.
